(19) United States
(12) Patent Application Publication
(10) Pub. No.: US 2026/0109163 A1
(43) Pub. Date: Apr. 23, 2026

(54) RECORDING DEVICE

(71) Applicant: SEIKO EPSON CORPORATION, Tokyo (JP)

(72) Inventor: Hibiki HARATA, SHIOJIRI-SHI (JP)

(21) Appl. No.: 19/357,612

(22) Filed: Oct. 14, 2025

(30) Foreign Application Priority Data
Oct. 17, 2024 (JP) 2024-182120

(51) Int. Cl. B41J 15/04; B41J 11/06; B41J 11/14; B41J 15/16

(52) U.S. Cl. CPC B41J 15/046; B41J 11/06; B41J 11/14; B41J 15/16

(57) ABSTRACT

A recording device 1 includes a transport roller pair 30 including a main roller 23 that applies transporting force for transporting a medium M in a transport direction, and sub-rollers 31 that are arranged at intervals G from each other along a rotation axis direction, each of the sub-rollers 31 nipping the medium M together with the main roller 23 at a nip position; a guide roller 24 that is arranged downstream of the transport roller pair 30 in the transport direction A and that applies tension to the medium M; and a recording section 27 that performs recording on the medium M transported between the transport roller pair 30 and the guide roller 24, wherein an axial center position 31c of a plurality of the sub-rollers 31 is arranged upstream of an axial center position 23c of the main roller 23 in the transport direction A.

The present application is based on, and claims priority from JP Application Serial Number 2024-182120, filed Oct. 17, 2024, the disclosure of which is hereby incorporated by reference herein in its entirety.

### BACKGROUND

### 1. Technical Field

The present disclosure relates to a recording device.

### 2. Related Art

In the related art, various recording devices that record an image on a transported medium have been used. Among these, there is a recording device including a transport roller that transports a medium and a tension applying roller that applies tension to the medium together with the transport roller. For example, JP-A-2024-90780 discloses a liquid ejection device including a transport section that transports a medium and that is configured of a first roller and a plurality of second rollers that press the medium against the first roller, and a guide roller that applies tension to the medium together with the first roller.

In a recording device that records an image on a transported medium, various mediums are used, such as a medium having high rigidity such as paper or a film, and a medium having low rigidity such as a fabric. The liquid ejection device of JP-A-2024-90780 can use various mediums such as paper sheet, a synthetic resin film, and a laminated medium including a synthetic resin layer and a metal layer as the medium. These are mediums having high rigidity, and the liquid ejection device of JP-A-2024-90780 can suitably transport such a medium.

On the other hand, the liquid ejection device of JP-A-2024-90780 includes the transport section that presses a medium against the first roller with the plurality of second rollers provided at intervals, and in such a configuration, for example, in a case where a medium having low rigidity such as a fabric is used, the medium is wound around the second roller, and a portion corresponding to an interval between the second rollers rises up with respect to the first roller, and thus, there is a possibility that wrinkles may occur along the transport direction of the medium. That is, in a case where a medium having high rigidity is used, it is possible to suppress the occurrence of wrinkles, but in a case where a medium having low rigidity is used, there is a possibility that it is not possible to suppress the occurrence of wrinkles. When wrinkles occur in a medium, the medium and a recording section may come into contact with each other.

### SUMMARY

In order to overcome the above-described problem, a recording device according to the present disclosure includes a transport roller pair including a main roller that applies a transporting force for transporting a medium in a transport direction, and sub-rollers that are arranged at intervals from each other along a rotation axis direction intersecting the transport direction, each of the sub-rollers nipping the medium together with the main roller at a nip position; a guide roller that is arranged downstream of the transport roller pair in the transport direction and that applies tension to the medium; and a recording section that performs recording on the medium transported between the transport roller pair and the guide roller, wherein an axial center position of a plurality of the sub-rollers is arranged upstream of an axial center position of the main roller in the transport direction.

### BRIEF DESCRIPTION OF THE DRAWINGS

FIG. 1 is a schematic side view showing a recording device according to a first embodiment of the present disclosure, and is a diagram showing a state in which sub-rollers that constitute a transport roller pair is separated from a main roller.

FIG. 2 is a schematic side view showing the recording device of FIG. 1, and is a diagram showing a state in which first sub-rollers of the sub-rollers that constitute the transport roller pair are in contact with the main roller.

FIG. 3 is a schematic side view showing the recording device of FIG. 1, and is a diagram showing a state in which second sub-rollers of the sub-rollers that constitute the transport roller pair are in contact with the main roller.

FIG. 4 is a schematic plan view showing the recording device of FIG. 1, and is a diagram showing the state in which the first sub-rollers of the sub-rollers that constitute the transport roller pair are in contact with the main roller.

FIG. 5 is a schematic side view showing a transport roller pair of a recording device according to a second embodiment of the present disclosure.

FIG. 6 is a schematic side view showing a transport roller pair of a recording device according to a third embodiment of the present disclosure

FIG. 7 is a schematic side view showing a transport roller pair of a recording device according to a fourth embodiment of the present disclosure

FIG. 8 is a schematic side view showing a recording device of a reference example.

FIG. 9 is a schematic plan view showing the recording device of FIG. 8.

### DESCRIPTION OF EMBODIMENTS

First, a brief outline of the present disclosure is described.

In order to overcome the above-described problem, a recording device according to a first aspect of the present disclosure includes a transport roller pair including a main roller that applies a transporting force for transporting a medium in a transport direction, and sub-rollers that are arranged at intervals from each other along a rotation axis direction intersecting the transport direction, each of the sub-rollers nipping the medium together with the main roller at a nip position; a guide roller that is arranged downstream of the transport roller pair in the transport direction and that applies tension to the medium; and a recording section that performs recording on the medium transported between the transport roller pair and the guide roller, wherein an axial center position of a plurality of the sub-rollers is arranged upstream of an axial center position of the main roller in the transport direction.

According to the present aspect, the transport roller pair that transports the medium in the transport direction, and the guide roller that is arranged downstream of the transport roller pair in the transport direction and that applies tension to the medium are provided. With such a configuration, it is possible to suppress the occurrence of wrinkles when a medium having high rigidity is used. The transport roller pair includes the main roller that applies the transporting force for transporting the medium in the transport direction, and the sub-rollers that are arranged at intervals from each other along the rotation axis direction intersecting the transport direction, each of the sub-rollers nipping the medium together with the main roller at the nip position. The axial center position of the plurality of sub-rollers is arranged upstream of the axial center position of the main roller in the transport direction. With such a configuration, even in a case where a medium having low rigidity is used, it is possible to suppress the medium from being wound around the sub-rollers and a portion corresponding to an interval between the sub-rollers from rising up with respect to the main roller. Therefore, it is possible to suppress the occurrence of wrinkles even when any of a medium having low rigidity and a medium having high rigidity is used.

A recording device according to a second aspect of the present disclosure is an aspect according to the first aspect, and the recording device further includes a position changing section configured to change the nip position in the transport direction by changing positions of the plurality of sub-rollers with respect to the main roller.

According to the present aspect, the position changing section configured to change the nip position in the transport direction by changing positions of the plurality of sub-rollers with respect to the main roller is provided. With such a configuration, for example, a desirable nip position can be set according to the type of the medium or the like, and the occurrence of wrinkles can be effectively suppressed even when any of a medium having low rigidity and a medium having high rigidity is used.

A recording device according to a third aspect of the present disclosure is an aspect according to the second aspect, and the position changing section is configured to change positions of the plurality of sub-rollers with respect to the main roller to a first nip position at which the nip position is arranged upstream in the transport direction with respect to the axial center position of the main roller and a second nip position at which the nip position is arranged downstream in the transport direction with respect to the axial center position of the main roller.

According to the present aspect, the position changing section is configured to change positions of the plurality of sub-rollers with respect to the main roller to the first nip position at which the nip position is arranged upstream in the transport direction with respect to the axial center position of the main roller and the second nip position at which the nip position is arranged downstream in the transport direction with respect to the axial center position of the main roller. With such a configuration, the first nip position can be set in a case where a medium having low rigidity is used, and the second nip position can be set in a case where a medium having high rigidity is used, and thus, it is possible to effectively suppress the occurrence of wrinkles even in a case where any of a medium having low rigidity and a medium having high rigidity is used.

A recording device according to a fourth aspect of the present disclosure is an aspect according to the third aspect, and the position changing section is configured to change the nip position to the first nip position or the second nip position based on a type of the medium.

According to the present aspect, the position changing section is configured to change the nip position to the first nip position or the second nip position based on the type of the medium. With such a configuration, for example, by control by a control section or the like, the first nip position can be automatically set in a case where a medium having low rigidity, that is, high elasticity is used, and the second nip position can be automatically set in a case where a medium having high rigidity, that is, low elasticity is used, and thus, it is possible to effectively suppress the occurrence of wrinkles even in a case where either a medium having low rigidity or a medium having high rigidity is used.

A recording device according to a fifth aspect of the present disclosure is an aspect according to the fourth aspect, and the first nip position includes a first distance position where an interaxial distance that is a distance in the transport direction between the axial center position of the plurality of sub-rollers and the axial center position of the main roller is a first distance, and a second distance position where the interaxial distance is a second distance longer than the first distance and the position changing section is configured to change positions of the plurality of sub-rollers with respect to the main roller at the first nip position to the first distance position or the second distance position based on the type of the medium.

According to the present aspect, the position changing section is configured to change positions of the plurality of sub-rollers with respect to the main roller at the first nip position to the first distance position or the second distance position based on the type of the medium. As an interaxial distance becomes longer at the first nip position, a medium is more likely to be wound around the main roller, and the effect of suppressing the occurrence of wrinkles becomes higher, but since it is possible to change positions of the plurality of sub-rollers with respect to the main roller to the first distance position or the second distance position based on the type of the medium, it is possible to effectively suppress the occurrence of wrinkles according to the type of the medium.

A recording device according to a sixth aspect of the present disclosure is an aspect according to any one of the first to fifth aspects, and the recording device further includes a support section that is arranged between the transport roller pair and the guide roller in the transport direction and that is provided at a position facing the recording section, wherein the support section is configured to switch between a support state in which the medium is supported by a support surface and a non-support state in which the medium is not supported by the support surface.

According to the present aspect, the support section is provided at the position facing the recording section, and the support section can be switched between the support state in which the medium is supported by the support surface and the non-support state in which the medium is not supported by the support surface. With such a configuration, it is possible to switch between stably performing recording while supporting the medium by the support surface and performing recording in a state where the occurrence of wrinkles is particularly suppressed without supporting the medium by the support surface, according to various conditions.

A recording device according to a seventh aspect of the present disclosure is an aspect according to the sixth aspect, and the support section is configured to switch between the support state and the non-support state based on a type of the medium.

According to the aspect, the support section is configured to switch between the support state and the non-support state based on the type of the medium. With such a configuration, for example, by control by the control section or the like, it is possible to automatically switch between stably performing recording while supporting the medium by the support surface and performing recording in a state where the occurrence of wrinkles is particularly suppressed without supporting the medium by the support surface according to the type of the medium.

A recording device according to an eighth aspect of the present disclosure is an aspect according to the sixth or seventh aspect, and a position of the support surface in the support state in a facing direction in which the support surface and the recording section face each other is a position closer to the recording section than the nip position.

According to the present aspect, the position of the support surface in the support state in the facing direction in which the support surface and the recording section face each other is the position closer to the recording section than the nip position. With such a configuration, for example, in a case where a medium having high rigidity such as paper is used, the medium can be suitably supported along the support surface, and accordingly, for example, it is possible to effectively suppress the recording section and the medium from being rubbed against each other.

A recording device according to a ninth aspect of the present disclosure is an aspect according to the eighth aspect, and the support section includes an inclined surface section connected to the support surface at an upstream end in the transport direction and the inclined surface section is closer the recording section in the facing direction with greater advancement in the transport direction.

According to the present aspect, the support section includes the inclined surface section that is provided at the upstream end in the transport direction, that is closer the recording section in the facing direction with greater advancement in the transport direction, and that is connected to the support surface. With such a configuration, the medium can be suitably transported to the support surface, and for example, in a case where a medium having high rigidity such as paper is used, the medium can be particularly suitably supported along the support surface.

### First Embodiment

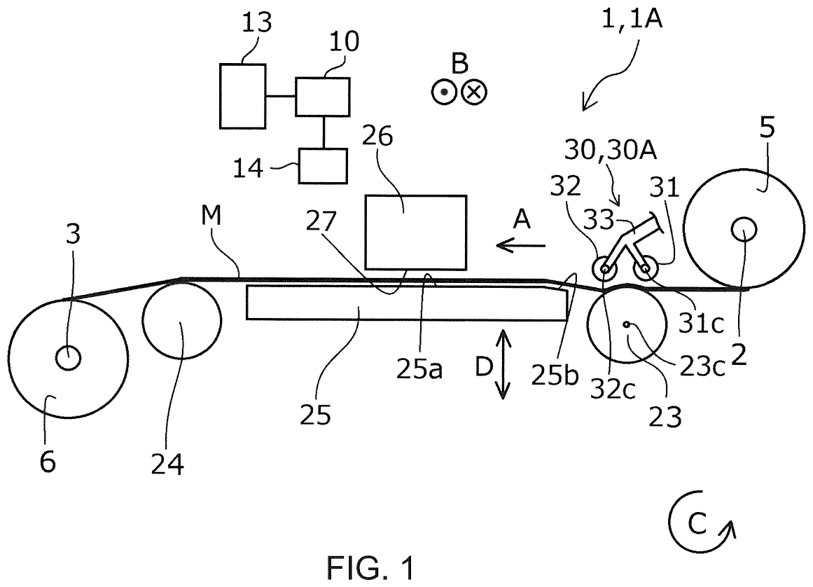

Hereinafter, an embodiment according to the present disclosure will be described with reference to the drawings. First, an outline of a recording device 1A of a first embodiment as an example of a recording device 1 of the present disclosure will be described with reference to FIGS. 1 to 4. As shown in FIG. 1, the recording device 1A of the present embodiment includes a control section 10. The control section 10 includes a CPU, a storage section, and the like (not shown), and controls driving of each constituent member of the recording device 1A. The recording device 1A includes a panel 13 that can notify various information in the recording device 1A and can input various instructions to the recording device 1A.

As shown in FIGS. 1 to 3, the recording device 1A of the present embodiment includes a holding section 2 that can rotatably hold a roll body 5 around which a medium M on which an image is formed are wound in a roll shape. The recording device 1A of the present embodiment includes a main roller 23 as a transport roller that transports the medium M in a transport direction A, and a head 27 as a recording section that forms an image by ejecting ink, which is liquid, onto the medium M transported by the main roller 23. The recording device 1A of the present embodiment includes a winding section 3 that can form a roll body 6 by winding the medium M on which an image is formed into a roll shape.

The holding section 2 holds a paper tube that constitutes a rotation shaft of the roll body 5, and is capable of rotating in a rotation direction C to feed the medium M from the roll body 5 to the main roller 23 of the recording device 1A. The holding section 2 may be configured separately from the recording device 1A, but may be a part of a constituent member of the recording device 1A.

The recording device 1A of the present embodiment is an inkjet printer that can form an image on the medium M by ejecting ink, which is liquid, in the form of droplets. The recording device 1A includes, as a transport section for the medium M, the main roller 23 that applies a transporting force for transporting the medium M in the transport direction A, and a guide roller 24 that also serves as a tension applying roller that applies tension to the medium M together with the main roller 23. Here, both the main roller 23 and the guide roller 24 are a single columnar roller extending in a width direction B.

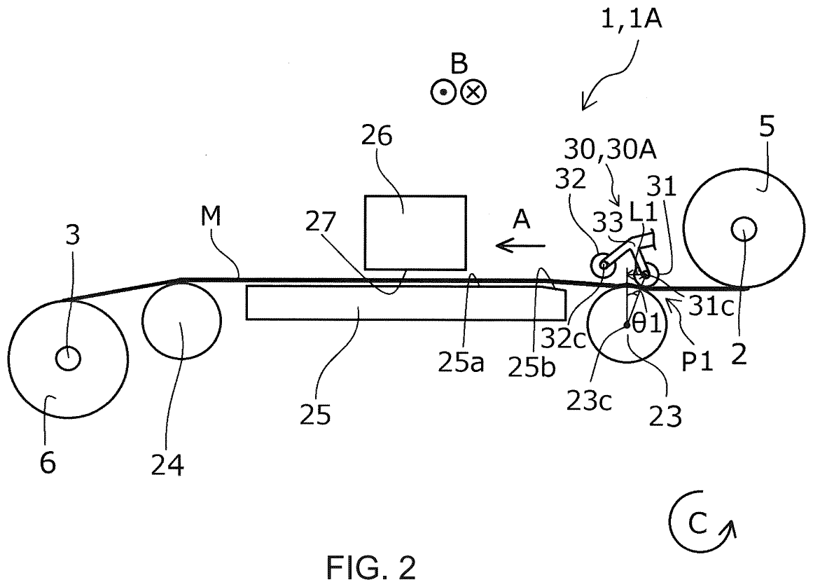

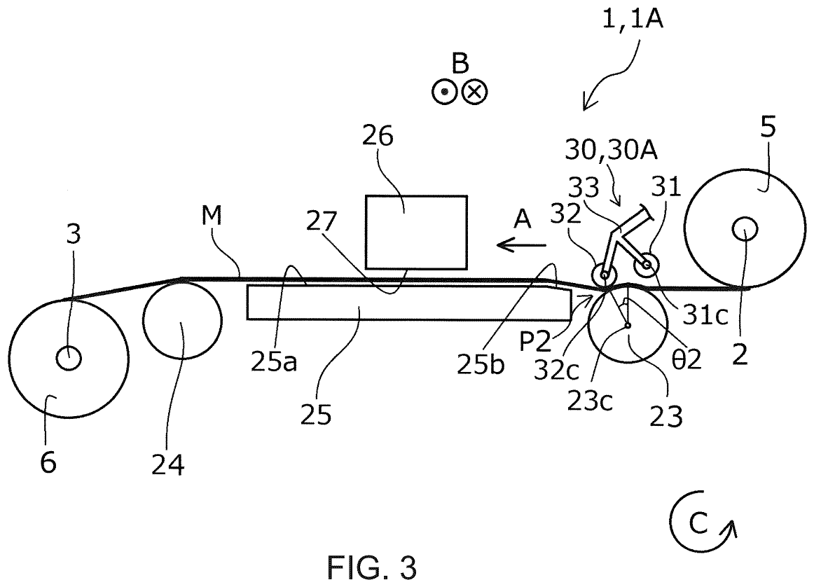

Here, as shown in FIGS. 1 to 3, the main roller 23 configures a transport roller pair 30 that transports the medium M in the transport direction A by nipping the medium M together with a first sub-roller 31 and a second sub-roller 32 as sub-rollers. The first sub-roller 31 and the second sub-roller 32 are formed on a bifurcated arm 33. The bifurcated arm 33 is configured to be rotatable in the rotation direction C and a direction opposite to the rotation direction C with reference to a rotation shaft (not shown) by driving a position changing section 14 shown in FIG. 1. By rotating the bifurcated arm 33, the first sub-roller 31 and the second sub-roller 32 can be separated from the main roller 23 as shown in FIG. 1, only the first sub-roller 31 can be brought into contact with the main roller 23 as shown in FIG. 2, and only the second sub-roller 32 can be brought into contact with the main roller 23 as shown in FIG. 3.

Here, in a state in which the first sub-roller 31 is in contact with the main roller 23 shown in FIG. 2, a first nip position P1, which is a nip position of the medium M by the main roller 23 and the first sub-roller 31, is a position upstream of an axial center position 23c of the main roller 23 in the transport direction A. On the other hand, in a state in which the second sub-roller 32 is in contact with the main roller 23 shown in FIG. 3, a second nip position P2, which is a nip position of the medium M by the main roller 23 and the second sub-roller 32, is a position downstream of the axial center position 23c of the main roller 23 in the transport direction A.

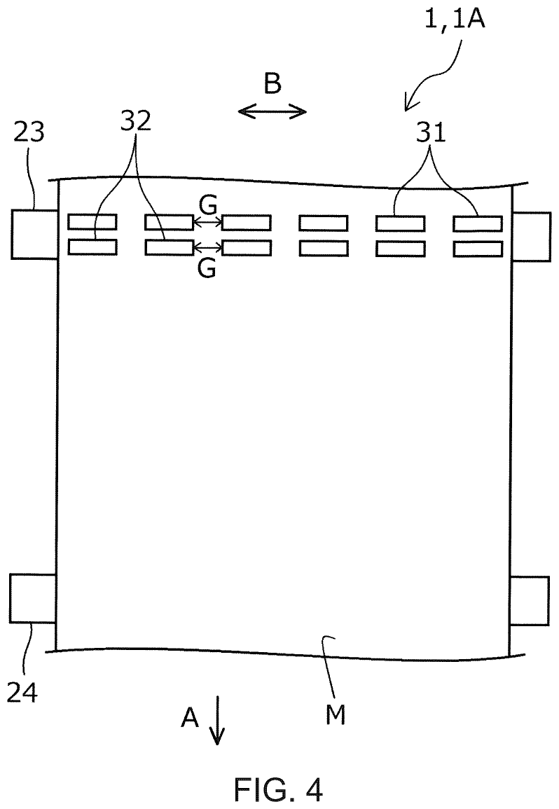

Note that the main roller 23 is a single columnar roller extending in the width direction B, whereas the first sub-rollers 31 and the second sub-rollers 32, which are both columnar sub-rollers, are both arranged at intervals G from each other along a rotation axis direction corresponding to the width direction B intersecting the transport direction A, as shown in FIG. 4. Each of the first sub-rollers 31 and each of the second sub-rollers 32 nip the medium M at each nip position together with the main roller 23. Here, the main roller 23 is a drive roller that is driven by a drive force from a motor (not shown) in order to apply a transporting force to the medium M, and thus is a single columnar roller extending in the width direction B. On the other hand, the first sub-rollers 31 and the second sub-rollers 32 are driven rollers that rotate together with the main roller 23 as the main roller 23 rotates, and thus are a plurality of columnar rollers that are arranged at the intervals G in the width direction B and are smaller than the main roller 23.

A platen 25 is provided between the transport roller pair 30A of the present embodiment as the transport roller pair 30 and the guide roller 24. As shown in FIG. 1, the platen 25 is configured to be movable in a vertical direction D. Since tension is applied to the medium M along the transport direction A between the transport roller pair 30A and the guide roller 24, the medium M can be transported in a state of floating with respect to a support surface 25a of the platen 25 by lowering the platen 25, and the medium M can be transported in a state of being supported by the support surface 25a of the platen 25 by raising the platen 25.

A movement direction of the main roller 23 and the guide roller 24 when transporting the medium M is the rotation direction C, and a medium support region between the transport roller pair 30A and the guide roller 24 is a region where ink is ejected from the head 27. Note that, except when an image is formed on the medium M, the main roller 23 and the guide roller 24 may be rotated in a direction opposite to the rotation direction C to move the medium M in a direction opposite to the transport direction A.

The recording device 1A of the present embodiment includes a carriage 26 capable of reciprocating in the width direction B intersecting the transport direction A, and the head 27 attached to the carriage 26. The head 27 is the recording section capable of forming an image by ejecting liquid ink onto the medium M transported in the transport direction A based on record data.

The recording device 1A of the present embodiment can form an image by ejecting ink from the head 27 onto the medium M being transported while reciprocating the carriage 26 in the width direction B, which intersects the transport direction A. By providing the carriage 26 with such a configuration, the recording device 1A of the present embodiment can form a desired image on the medium M by repeating transport of the medium M in the transport direction A by a predetermined transport amount and ejection of ink while moving the carriage 26 in the width direction B in a state where the medium M is stopped. However, the configuration of the recording section is not particularly limited. For example, a so-called line head in which nozzles that eject ink are provided across the entire width direction B of the medium M may be used as the ejection section.

As described above, the recording device 1A of the present embodiment includes the winding section 3. The medium M on which an image is formed by ejecting ink from the head 27 is wound into the roll body 6 by the winding section 3. The winding section 3 holds a paper tube as a rotation shaft for forming the roll body 6, and rotates in the rotation direction C to wind the medium M around the paper tube, thereby forming the roll body 6. The winding section 3 may be configured separately from the recording device 1A, but may be a part of a constituent member of the recording device 1A. A drying device or the like for drying ink ejected onto the medium M may be provided between the winding section 3 and the recording device 1A.

Here, in the recording device 1A of the present embodiment, for example, a material to be printed which is a fabric can be used as the medium M. The material to be printed refers to a fabric, a garment, other clothing products, and the like that are the subject of printing. Fabrics include woven, knitted, and nonwoven fabrics made of natural fibers such as cotton, silk, and wool, synthetic fibers such as nylon, or composite fibers mixed with these fibers. Garments and other clothing products include sewn T-shirts, handkerchiefs, scarves, towels, handbags, bags made of fabric, curtains, sheets, bed covers, and other furniture, as well as fabrics before and after cutting, which exist as parts before being sewn together. In the recording device 1A of the present embodiment, various materials such as paper such as copy paper or special paper for inkjet recording, and a film can be used as the medium M, in addition to the fabric.

As described above, the recording device 1A of the present embodiment includes the transport roller pair r 30A including the main roller 23 that applies a transporting force for transporting the medium M in the transport direction A, and the first sub-rollers 31 and the second sub-rollers 32 as sub-rollers that are arranged at the intervals G from each other along the rotation axis direction intersecting the transport direction A, each of the sub-rollers nipping the medium M together with the main roller 23 at the nip position. The recording device 1A of the present embodiment includes the guide roller 24 that is arranged downstream of the transport roller pair 30A in the transport direction A and that applies tension to the medium M, and the head 27 that performs recording on the medium M transported between the transport roller pair 30A and the guide roller 24.

Hereinafter, the details of the transport roller pair 30A of the present embodiment will be further described. As shown in FIGS. 1 to 3, in the transport roller pair 30A of the present embodiment, the first sub-rollers 31 and the second sub-rollers 32 are provided on the bifurcated arm 33 which is a bifurcated arm section. The bifurcated arm 33 is configured to be rotatable in the rotation direction C and a rotation direction opposite to the rotation direction C with reference to a rotation shaft (not shown) by driving the position changing section 14 shown in FIG. 1. When the bifurcated arm 33 rotates in the rotation direction opposite to the rotation direction C with reference to the rotation shaft from the state shown in FIG. 1, the first sub-rollers 31 come into contact with the main roller 23 as shown in FIG. 2. On the other hand, when the bifurcated arm 33 rotates in the rotation direction C with reference to the rotation shaft from the state shown in FIG. 1, the second sub-rollers 32 come into contact with the main roller 23 as shown in FIG. 3.

Here, the first nip position P1, which is a nip position of the medium M by the first sub-roller 31 and the main roller 23 shown in FIG. 2, is on an upstream side of the axial center position 23c of the main roller 23 in the transport direction A. By nipping the medium M by the first sub-roller 31 and the main roller 23 at such a nip position, the medium M transported from the transport roller pair 30A are wound around the main roller 23 extending in the width direction B on the most downstream side in the transport direction A.

On the other hand, the second nip position P2, which is a nip position of the medium M by the second sub-roller 32 and the main roller 23 shown in FIG. 3, is on a downstream side of the axial center position 23c of the main roller 23 in the transport direction A. By nipping the medium M by the second sub-roller 32 and the main roller 23 at such a nip position, the medium M transported from the transport roller pair 30A are wound around the second sub-rollers 32 provided at the intervals G from each other in the width direction B, not around the main roller 23, on the most downstream side in the transport direction A.

As described above, the recording device 1A of the present embodiment can change the nip position of the medium M to the first nip position P1 that is on an upstream side of the axial center position 23c of the main roller 23 in the transport direction A and the second nip position P2 that is on a downstream side of the axial center position 23c of the main roller 23 in the transport direction A. Note that when a soft medium having high elasticity, such as a fabric, are used as the medium M, if a downstream side of the axial center position 23c of the main roller 23 is set as the nip position of the medium M, wrinkles W may occur. Hereinafter, such a case will be described with reference to the recording device 1A of the present embodiment, in comparison with a recording device 1E of a reference example.

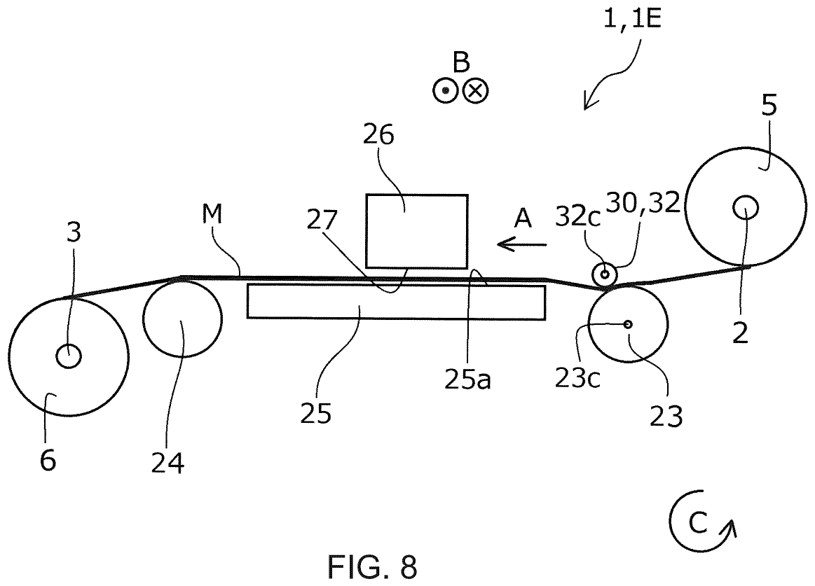

Here, FIG. 8 is a schematic side view of the recording device 1E of the reference example. As shown in FIG. 8, the recording device 1E of the reference example includes, as the transport roller pair 30, the main roller 23 including the same configuration as that of the recording device 1A of the present embodiment, and sub-rollers including the same configuration as that of the second sub-rollers 32 of the recording device 1A of the present embodiment. In other words, sub-rollers including a configuration corresponding to the first sub-rollers 31 of the recording device 1A of the present embodiment is not provided. Therefore, even when soft medium having high elasticity such as a fabric are used as the medium M, the transport roller pair 30 of the recording device 1E of the reference example nips the medium M at the nip position on a downstream side of the axial center position 23c of the main roller 23 in the transport direction A.

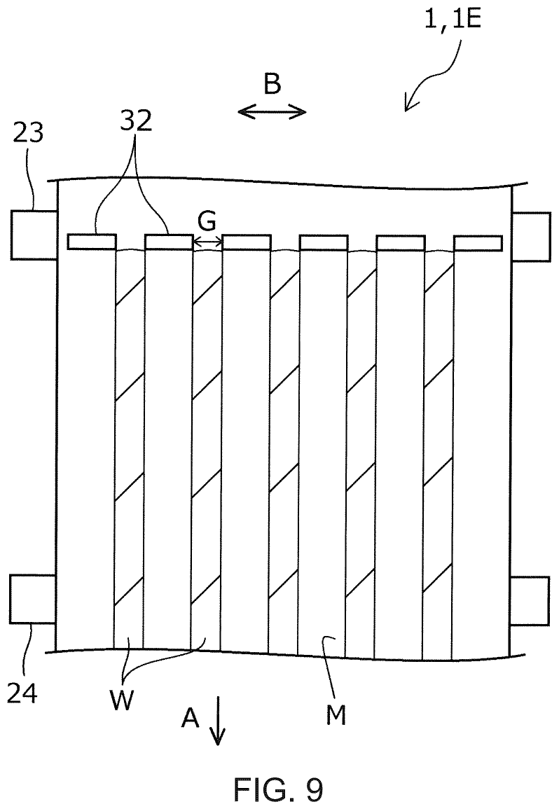

In such a case, the medium M transported from the transport roller pair 30 is wound around the sub-rollers provided at the intervals G from each other in the width direction B, instead of the main roller 23, on the most downstream side of the transport roller pair 30 in the transport direction A. Then, in a region corresponding to the interval G between the sub-rollers, the medium M is transported in a state of being raised upward, and as shown in FIG. 9, the wrinkles W are occurred in the region corresponding to the interval G between the sub-rollers.

On the other hand, as described above, the recording device 1A of the present embodiment can transport the medium M while nipping the medium M at the first nip position P1 as shown in FIG. 2. In other words, when soft medium having high elasticity such as a fabric are used, the medium M can be transported while being wound around the main roller 23 extending in the width direction B on the most downstream side of the transport roller pair 30 in the transport direction A by transporting the medium M while nipping the medium M at the first nip position P1. By transporting the medium M in this manner, as shown in FIG. 4, the medium M can be transported without generating the wrinkles W.

In this manner, the recording device 1A of the present embodiment can set the nip position of the medium M to the first nip position P1 that is on an upstream side of the axial center position 23c of the main roller 23 in the transport direction A. From another point of view, in the recording device 1A of the present embodiment, an axial center position 31c of the plurality of first sub-rollers 31 is arranged upstream of the axial center position 23c of the main roller 23 in the transport direction A.

As in the recording device 1A of the present embodiment, by adopting a configuration including the transport roller pair 30 that transports the medium M in the transport direction A, and the guide roller 24 that is arranged downstream of the transport roller pair 30 in the transport direction A and that applies tension to the medium M, it is possible to suppress the occurrence of the wrinkles W in a case where the medium M having high rigidity is used. As described above, in the recording device 1A of the present embodiment, the transport roller pair 30 includes the main roller 23 that applies a transporting force for transporting the medium M in the transport direction A, and sub-rollers (the first sub-rollers 31 and the second sub-rollers 32) that are arranged at the intervals G from each other along the rotation axis direction intersecting the transport direction A, each of the sub-rollers nipping the medium M together with the main roller 23 at the nip position.

The axial center position 31c of the first sub-rollers 31 among the sub-rollers is arranged upstream of the axial center position 23c of the main roller 23 in the transport direction A. With this configuration, the recording device 1A of the present embodiment can prevent a portion corresponding to the interval G between the sub-rollers from being rising up from the main roller 23 due to the winding of the medium M around the sub-rollers even when the medium M having low rigidity is used. This is because, when the medium M is transported from the transport roller pair 30, the medium M is transported in a state of being wound around the main roller 23 not having the intervals G, not the sub-rollers having the intervals G, on the most downstream side in the transport direction A. Note that, when the medium M having high rigidity is used, a high transporting force may be required, but it is possible to suppress the occurrence of the wrinkles W even when the axial center position 31c of the sub-rollers is arranged upstream of the axial center position 23c of the main roller 23 in the transport direction A. Therefore, the recording device 1A of the present embodiment can suppress the occurrence of the wrinkles W even when any of the medium M having low rigidity and the medium M having high rigidity is used.

Hereinafter, a determination reference for determining whether the first nip position P1 or the second nip position P2 is set in the recording device 1A of the present embodiment will be described. In the recording device 1A of the present embodiment, the control section 10 determines whether to set the first nip position P1 or the second nip position P2 based on the ease of bleed-through in which ink ejected onto the medium M permeates from a front surface (surface on a side where ink is ejected) to a back surface and the ease of occurrence of the wrinkles W. Basically, when the medium M made of paper or film is used, the second nip position P2 is set. On the other hand, when the medium M made of fabric is used, the first nip position P1 or the second nip position P2 is individually determined depending on the type of the medium M. A user can input the type of the medium M to be used via the panel 13.

Here, presence or absence of bleed-through of ink, presence or absence of the occurrence of the wrinkles W, the density and the rigidity as the properties of the medium M, and specific examples of the medium are collectively shown in Table 1 below. In the recording device 1A of the present embodiment, in Table 1, when the medium M in which the wrinkles W occur is used, the first nip position P1 is set, and when the medium M in which the wrinkles W do not occur is used, the second nip position P2 is set. Note that the second nip position P2 is more likely to cause the wrinkles W than the first nip position P1, but a transporting force of the medium M is larger.

TABLE 1

| BLEED- | OCCURRENCE | | |
|---|---|---|---|
| THROUGH OF INK | OF WRINKLES | PROPERTIES OF MEDIUM | SPECIFIC EXAMPLES OF MEDIUM |
| ABSENCE | ABSENCE | DENSITY “HIGH” × RIGIDITY “HIGH” | PAPER, 8 oz CANVAS (PLAIN WEAVE) |
| ABSENCE | PRESENCE | DENSITY “HIGH” × RIGIDITY “LOW” | TETRE TWILL (TWILL WEAVE) |
| PRESENCE | ABSENCE | DENSITY “LOW” × RIGIDITY “HIGH” | 80/1 COTTON ORGANDY (PLAIN WEAVE) |
| PRESENCE | PRESENCE | DENSITY “LOW” × RIGIDITY “LOW” | CUPRA TWILL (TWILL WEAVE) |

The factors that determine the density and the rigidity of the medium M will be described in more detail. First, the density of the medium M will be described. The number of threads constituting the medium M is related to the density of the medium M. The density of the medium M is determined by the number of threads included in a certain area, and the density of the medium M becomes higher as the numbers of warp threads and weft threads per inch (2.54 cm) are larger.

The thickness of a thread constituting the medium M is also related to the density of the medium M. When a thick thread is used, a medium M having high density can be produced even with a small number of threads, and when a thin thread is used, a large number of threads are required to produce a medium M having high density.

A weaving method (plain weave, twill weave, satin weave, or the like) of a thread constituting the medium M is also related to the density. By using different weaving methods, the arrangement and the way of binding of threads are changed, and the arrangement and the way of binding of the threads change the density of the medium M. Specifically, for example, the density of the medium M is satin weave>twill weave>plain weave.

A finishing process of the medium M is also related to the density. This is because the finishing process performed on the medium M, such as coating or resin processing, may increase the density by filling gaps between threads.

Next, the rigidity of the medium M will be described. The type of fiber constituting the medium M is related to the rigidity. The type of fiber used, such as cotton, polyester, nylon, or the like, has a significant impact on the rigidity of the medium M, with different fibers having different physical properties that alter the rigidity of the overall medium M.

The thickness and density of a thread constituting the medium M are also related to the rigidity. The thickness of a thread constituting the medium M and the density of the medium M (the number of threads) are directly related to the rigidity of the medium M, and the medium M constituted by a thick thread and the medium M having high density generally have high rigidity.

A weaving method of threads constituting the medium M is also related to the rigidity. A weaving method of a thread constituting the medium M such as plain weave, twill weave, or satin weave also affects the rigidity, and plain weave generally has high rigidity, and satin weave feels soft. Specifically, for example, the rigidity of the medium M is plain weave>twill weave>satin weave.

A finishing process of the medium M is also related to the rigidity. A finishing process performed on the medium M, such as coating or resin processing, may increase the rigidity of the medium M. By increasing the rigidity of the medium M, the medium M becomes stiff and firm to the touch.

The humidity and temperature in installation environment of the recording device 1 are also related to the rigidity. Environmental conditions also affect the rigidity of the medium M, and the medium M may become soft when the humidity is high, and the medium M may become stiff at low temperatures.

As described above, the transport roller pair 30A of the present embodiment can nip the medium M at the first nip position P1, which is a position upstream of the axial center position 23c of the main roller 23 in the transport direction A, by the main roller 23 and the first sub-rollers 31, and can nip the medium M at the second nip position P2, which is a position downstream of the axial center position 23c of the main roller 23 in the transport direction A, by the main roller 23 and the second sub-rollers 32. In other words, the recording device 1A of the present embodiment includes the position changing section 14 that can change the nip position in the transport direction A by changing positions of the plurality of sub-rollers with respect to the main roller 23. By configuring the recording device 1A of the present embodiment in this manner, for example, it is possible to set a desirable nip position according to the type of the medium M or the like, and it is possible to effectively suppress the occurrence of the wrinkles W even when using medium M having low rigidity or medium M having high rigidity.

Specifically, the position changing section 14 can change positions of the plurality of sub-rollers with respect to the main roller 23 to the first nip position P1 at which the nip position is arranged upstream in the transport direction A with respect to the axial center position 23c of the main roller 23 and the second nip position P2 at which the nip position is arranged downstream in the transport direction A with respect to the axial center position 23c of the main roller 23. By configuring the recording device 1A of the present embodiment in this manner, the first nip position P1 can be set when the medium M having low rigidity are used, and the second nip position P2 can be set when the medium M having high rigidity are used, and the occurrence of the wrinkles W can be effectively suppressed when the medium M having low rigidity or the medium M having high rigidity are used.

Furthermore, the position changing section 14 is configured to be able to change the nip position to either the first nip position P1 or the second nip position P2 based on the type of the medium M under the control of the control section 10. With this configuration, the recording device 1A of the present embodiment can automatically set the first nip position P1 when the medium M having low rigidity, that is, high elasticity, is used, and set the second nip position P2 when the medium M having high rigidity, that is, low elasticity, is used, and can effectively suppress the occurrence of the wrinkles W when the medium M having low rigidity or the medium M having high rigidity is used. The type of the medium M here can be read as, for example, the rigidity of the medium M, the elasticity of the medium M, or the like.

Here, the recording device 1A of the present embodiment is configured to be able to move positions of the sub-rollers along the transport direction A by driving the position changing section 14 under the control of the control section 10 and moving the bifurcated arm 33 along the transport direction A. Therefore, a position of the first nip position P1 in the transport direction A can be finely adjusted based on the type of the medium M to be used. In other words, the recording device 1A of the present embodiment includes, as the first nip position P1, a first distance position at which an interaxial distance L1, which is a distance in the transport direction A between the axial center position 31c of the first sub-rollers 31 as the plurality of sub-rollers shown in FIG. 2 and the axial center position 23c of the main roller 23, is a first distance, and a second distance position at which the interaxial distance L1 is a second distance longer than the first distance. The position changing section 14 is configured to be able to change positions of the plurality of first sub-rollers 31 with respect to the main roller 23 at the first nip position P1 to the first distance position or the second distance position based on the type of the medium M under the control of the control section 10.

As the interaxial distance L1 becomes longer at the first nip position P1, the medium M are more likely to be wound around the main roller 23, and the effect of suppressing the occurrence of the wrinkles W becomes greater. The recording device 1A of the present embodiment can change positions of the plurality of first sub-rollers 31 with respect to the main roller 23 to the first distance position or the second distance position based on the type of the medium M, and thus can effectively suppress the occurrence of the wrinkles W according to the type of the medium M.

Note that the further upstream the first nip position P1 is in the transport direction A, the longer the length of the medium M that is wound around the main roller 23, and thus the effect of suppressing the occurrence of the wrinkles W increases, and thus the control section 10 of the recording device 1A of the present embodiment can position the first nip position P1 upstream in the transport direction A for medium M that is more likely to have the wrinkles W, such as the medium M having low rigidity or medium M having high elasticity (stretchability). Here, the state shown in FIG. 2 corresponds to the first distance position in which the interaxial distance L1 is the first distance, and in a case where the medium M having particularly low rigidity is used, positions of the first sub-rollers 31 are moved further upstream in the transport direction A than the state shown in FIG. 2, and the interaxial distance L1 is set to the second distance position in which the interaxial distance L1 is the second distance.

However, the further upstream the first nip position P1 is in the transport direction A, the more force is exerted by the medium M to lift the first sub-rollers 31, that is, the greater a load on the first sub-rollers 31 is, which may result in adverse effects such as a deterioration in transport accuracy, therefore, it is desirable to adjust the precise position of the first nip position P1 in the transport direction A within a range in which transport accuracy is guaranteed. For example, as shown in FIG. 2, it is desirable that an angle θ1 of a line connecting the axial center position 23c of the main roller 23 in the transport direction A and a contact position with the first nip position P1, which is taken as a reference line and extends vertically upward from the axial center position 23c, is greater than or equal to 15° and less than or equal to 30° on an upstream side in the transport direction A. However, it is desirable to determine this based on the ease with which the wrinkles W are formed in the medium M, such as the height of rigidity.

On the other hand, as shown in FIG. 3, an angle θ2 of a line connecting the axial center position 23c of the main roller 23 in the transport direction A and a contact position with the second nip position P2, which is taken as a reference line and extends vertically upward from the axial center position 23c, is set to 10° on a downstream side in the transport direction A in the recording device 1A of the present embodiment, and is fixed at this position. This is because there is no merit in adjusting the second nip position P2 depending on the type of medium M.

As described above, the recording device 1A of the present embodiment includes the platen 25 that is movable in the vertical direction D. From another point of view, the recording device 1A of the present embodiment includes the platen 25 that is arranged between the transport roller pair 30A and the guide roller 24 in the transport direction A and that is provided at a position facing the head 27, and the platen 25 is configured to be switchable between a support state in which the medium M is supported by a support surface 25a and a non-support state in which the medium M is not supported by the support surface 25a.

By adopting such a configuration, the recording device 1A of the present embodiment can switch between stably performing recording while supporting the medium M by the support surface 25a and performing recording in a state in which the occurrence of the wrinkles W is particularly suppressed without supporting the medium M by the support surface 25a, in accordance with various conditions. The recording device 1A of the present embodiment is configured to switch between the support state and the non-support state by moving the platen 25 up and down. However, the present disclosure is not limited to such a configuration, and the support surface 25a, that is, the platen 25 may be configured to be detachable from the main body portion of the recording device 1.

Furthermore, the recording device 1A of the present embodiment is configured to be able to move the platen 25 in the vertical direction D, that is, to be able to switch the platen 25 between the support state and the non-support state, based on the type of the medium M under the control of the control section 10. By adopting such a configuration, the recording device 1A of the present embodiment can automatically switch between stably performing recording while supporting the medium M by the support surface 25a and performing recording in a state in which the occurrence of the wrinkles W is particularly suppressed without supporting the medium M by the support surface 25a, according to the type of the medium M.

In the recording device 1A of the present embodiment, for example, in a case where paper, a fabric having high density, or a thick fabric is used as the medium M, the amount of bleed-through of ink is relatively small, and thus the platen 25 can be arranged so as to be in the support state. On the other hand, in a case where a fabric having low density or a thin fabric is used as the medium M, the amount of bleed-through of ink is relatively large, and thus, the platen 25 can be arranged so as to be in the non-support state. The type of the medium M here can be read as the density of the medium M, the thickness of the medium M, or the like.

Here, in the recording device 1A of the present embodiment, a position of the platen 25 in the vertical direction D in the support state is above the first nip position P1 and the second nip position P2. In other words, in the recording device 1A of the present embodiment, a position of the support surface 25a in the support state in a facing direction in which the support surface 25a and the head 27 face each other is configured to be a position closer to the head 27 than the first nip position P1 and the second nip position P2, which are the nip positions. By configuring the recording device 1A of the present embodiment in this manner, for example, in a case where the medium M having high rigidity such as paper are used, the medium M can be suitably supported along the support surface 25a, and thus, for example, rubbing between the head 27 and the medium M can be effectively suppressed.

As shown in FIGS. 1 to 3, in the recording device 1A of the present embodiment, the platen 25 includes an inclined surface section 25b connected to the support surface 25a at an upstream end in the transport direction A. The inclined surface section 25b is configured to be directed upward as it advances in the transport direction A. In other words, the inclined surface section 25b is configured to approach the head 27 in the facing direction of the support surface 25a and the head 27. By configuring the recording device 1A of the present embodiment in this manner, the medium M can be suitably transported to the support surface 25a, and for example, in a case where the medium M having high rigidity such as paper are used, the medium M can be particularly suitably supported along the support surface 25a.

### Second Embodiment

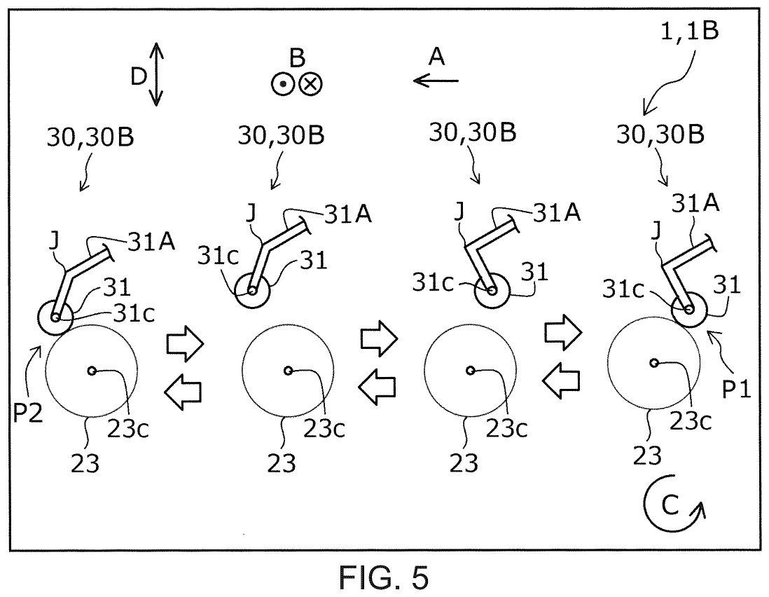

Next, a recording device 1B of a second embodiment will be described with reference to FIG. 5. In FIG. 5, constituent members common to those of the first embodiment are denoted by the same reference symbols, and detailed description thereof will be omitted. Here, the recording g device 1B of the present embodiment includes the same configuration as the recording device 1A of the first embodiment except for the parts described below. Therefore, the recording device 1B of the present embodiment has the same features as those of the recording device 1A of the first embodiment, except for the parts described below.

As described above, in the transport roller pair 30A of the recording device 1A of the first embodiment, the two sub-rollers of the first sub-roller 31 and the second sub-roller 32 are formed on the bifurcated arm 33. On the other hand, as shown in FIG. 5, in a transport roller pair 30B of the recording device 1B of the present embodiment, the first sub-roller 31 that is one sub-roller is provided on a joint arm 31A that is bent with a joint J as a reference. The joint arm 31A is configured to be bent with respect to the joint J and to be movable in the vertical direction D as a whole. A movement of the joint arm 31A and a bending operation with reference to the joint J are performed by driving the position changing section 14.

The rightmost state in FIG. 5 shows a state in which the first sub-roller 31 is at the first nip position P1 by bending the joint J of the joint arm 31A to a large extent and lowering the joint arm 31A downward. That is, the axial center position 31c of the plurality of first sub-rollers 31 is arranged upstream of the axial center position 23c of the main roller 23 in the transport direction A.

A second state from the right in FIG. 5 shows a state in which the first sub-roller 31 is separated from the main roller 23 by raising the joint arm 31A upward from the rightmost state in FIG. 5 while the joint J of the joint arm 31A is bent largely. A second state from the left in FIG. 5 shows a state in which a bending angle of the joint J of the joint arm 31A is reduced from the second state from the right in FIG. 5, and the joint arm 31A is moved to a downstream side in the transport direction A while the joint arm 31A is raised upward. The second state from the left in FIG. 5 also shows a state in which the first sub-roller 31 is separated from the main roller 23.

The leftmost state in FIG. 5 shows a state in which the joint arm 31A is lowered downward from the second state from the left in FIG. 5 while the bending angle of the joint J of the joint arm 31A is kept small, and the first sub-roller 31 is at the second nip position P2. That is, the axial center position 31c of the plurality of first sub-rollers 31 is arranged downstream of the axial center position 23c of the main roller 23 in the transport direction A.

In the recording device 1B of the present embodiment, similarly to the recording device 1A of the first embodiment, the sub-rollers can be arranged at the first nip position P1 in a case where the medium M having low rigidity is used, and can be arranged at the second nip position P2 in a case where the medium M having high rigidity is used. That is, the recording device 1B of the present embodiment can also effectively suppress the occurrence of the wrinkles W even when any of the medium M having low rigidity and the medium M having high rigidity is used.

### Third Embodiment

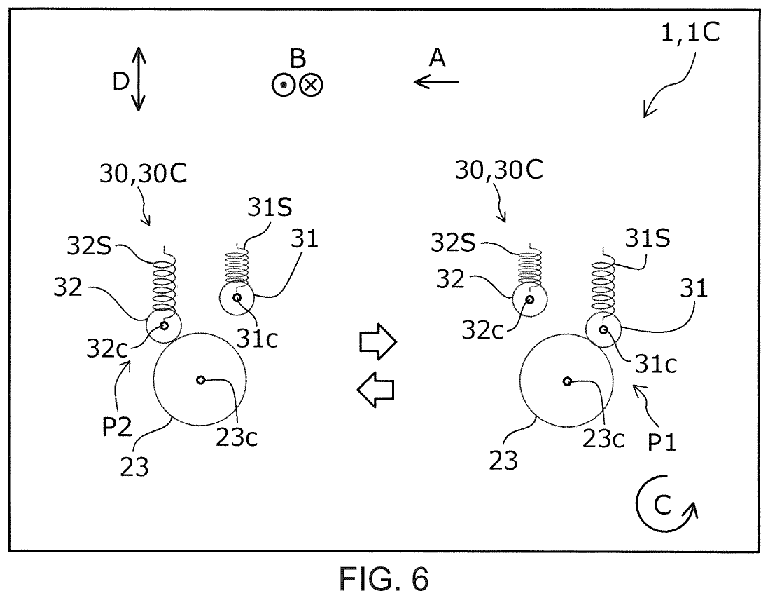

Next, a recording device 1C of a third embodiment will be described with reference to FIG. 6. In FIG. 6, constituent members common to those of the first embodiment and the second embodiment are denoted by the same reference symbols, and detailed description thereof will be omitted. Here, the recording device 1C of the present embodiment includes the same configuration as the recording device 1 of the first embodiment and the second embodiment except for the parts described below. Therefore, the recording device 1C of the present embodiment has the same features as those of the recording device 1 of the first embodiment and the second embodiment, except for the parts described below.

As shown in FIG. 6, a transport roller pair 30C of the recording device 1C of the present embodiment includes two sub-rollers of the first sub-roller 31 and the second sub-roller 32. A spring 31S is connected to the first sub-roller 31, and a spring 32S is connected to the second sub-roller 32. Since the transport roller pair 30C of the present embodiment includes such a configuration, both the first sub-roller 31 and the second sub-roller 32 are configured to be movable in the vertical direction D. The first sub-roller 31 and the second sub-roller 32 are moved up and down by driving the position changing section 14.

The right state in FIG. 6 shows a state in which the first sub-roller 31 is lowered downward so that the first sub-roller 31 is at the first nip position P1, and the second sub-roller 32 is raised upward so that the second sub-roller 32 is separated from the main roller 23. Here, the axial center position 31c of the plurality of first sub-rollers 31 is arranged upstream of the axial center position 23c of the main roller 23 in the transport direction A.

On the other hand, the left state in FIG. 6 shows a state in which the second sub-roller 32 is lowered downward so that the second sub-roller 32 is at the second nip position P2, and the first sub-roller 31 is raised upward so that the first sub-roller 31 is separated from the main roller 23. Here, the axial center position 32c of the plurality of second sub-rollers 32 is arranged downstream of the axial center position 23c of the main roller 23 in the transport direction A.

In the recording device 1C of the present embodiment, similarly to the recording devices 1 of the first embodiment and the second embodiment, the sub-rollers can be arranged at the first nip position P1 in a case where the medium M having low rigidity is used, and can be arranged at the second nip position P2 in a case where the medium M having high rigidity is used. That is, the recording device 1C of the present embodiment can also effectively suppress the occurrence of the wrinkles W even when any of the medium M having low rigidity and the medium M having high rigidity is used.

### Fourth Embodiment

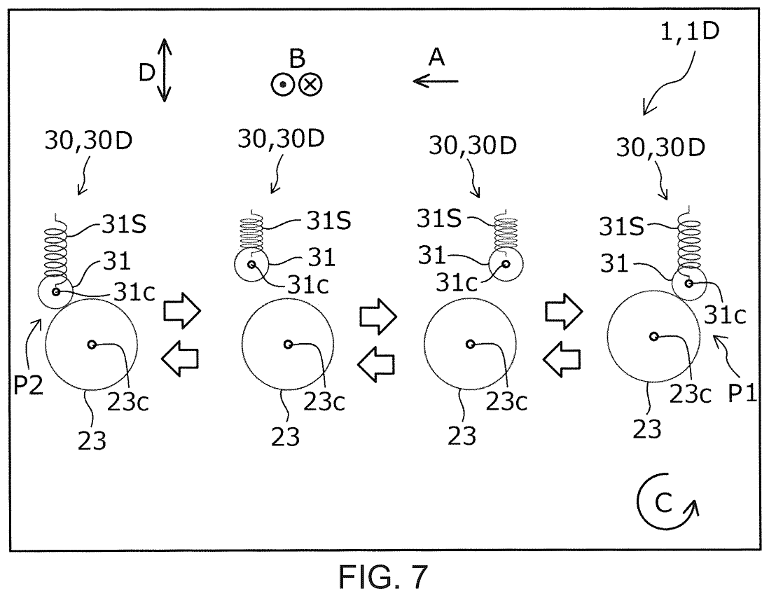

Next, a recording device 1D of a fourth embodiment will be described with reference to FIG. 7. In FIG. 7, constituent members common to those of the first embodiment to the third embodiment are denoted by the same reference symbols, and detailed description thereof will be omitted. Here, the recording device 1D of the present embodiment includes the same configuration as the recording device 1 of the first embodiment to the third embodiment except for the parts described below. Therefore, the recording device 1D of the present embodiment has the same features as those of the recording device 1 of the first embodiment to the third embodiment, except for the parts described below.

As shown in FIG. 7, a transport roller pair 30D of the recording device 1D of the present embodiment includes the first sub-roller 31 that is one sub-roller. The spring 31S is connected to the first sub-roller 31, and the first sub-roller 31 and the spring 31S are configured to be movable along the transport direction A. Since the transport roller pair 30D of the present embodiment includes such a configuration, the first sub-roller 31 is configured to be movable in both a direction along the transport direction A and the vertical direction D. The first sub-roller 31 is moved up and down and in the direction along the transport direction A by driving the position changing section 14.

The rightmost state in FIG. 7 shows a state in which the first sub-roller 31 is moved upstream in the transport direction A and lowered downward so that the first sub-roller 31 is at the first nip position P1. That is, the axial center position 31c of the plurality of first sub-rollers 31 is arranged upstream of the axial center position 23c of the main roller 23 in the transport direction A.

A second state from the right in FIG. 7 shows a state in which the first sub-roller 31 is raised upward from the rightmost state in FIG. 7. A second state from the left in FIG. 7 shows a state in which the first sub-roller 31 is moved downstream in the transport direction A from the second state from the right in FIG. 7 while the first sub-roller 31 is raised upward. The second state from the left in FIG. 7 also shows a state in which the first sub-roller 31 is separated from the main roller 23.

The leftmost state in FIG. 7 shows a state in which the first sub-roller 31 is lowered downward from the second state from the left in FIG. 7 and the first sub-roller 31 is at the second nip position P2. That is, the axial center position 31c of the plurality of first sub-rollers 31 is arranged downstream of the axial center position 23c of the main roller 23 in the transport direction A.

In the recording device 1D of the present embodiment, similarly to the recording devices 1 of the first embodiment to the third embodiment, the sub-rollers can be arranged at the first nip position P1 in a case where the medium M having low rigidity is used, and can be arranged at the second nip position P2 in a case where the medium M having high rigidity is used. That is, the recording device 1D of the present embodiment can also effectively suppress the occurrence of the wrinkles W even when any of the medium M having low rigidity and the medium M having high rigidity is used.

Note that the present disclosure is not limited to the above-described embodiments, and various modifications can be made within the scope of the disclosure described in the claims, and it goes without saying that they are also included in the scope of the present disclosure.

What is claimed is:

1. A recording device comprising:
a transport roller pair including a main roller that applies a transporting force for transporting a medium in a transport direction, and sub-rollers that are arranged at intervals from each other along a rotation axis direction intersecting the transport direction, each of the sub-rollers nipping the medium together with the main roller at a nip position;
a guide roller that is arranged downstream of the transport roller pair in the transport direction and that applies tension to the medium; and
a recording section that performs recording on the medium transported between the transport roller pair and the guide roller, wherein
an axial center position of a plurality of the sub-rollers is arranged upstream of an axial center position of the main roller in the transport direction.

2. The recording device according to claim 1, further comprising:
a position changing section configured to change the nip position in the transport direction by changing positions of the plurality of sub-rollers with respect to the main roller.

3. The recording device according to claim 2, wherein
the position changing section is configured to change positions of the plurality of sub-rollers with respect to the main roller to a first nip position at which the nip position is arranged upstream in the transport direction with respect to the axial center position of the main roller and a second nip position at which the nip position is arranged downstream in the transport direction with respect to the axial center position of the main roller.

4. The recording device according to claim 3, wherein
the position changing section is configured to change the nip position to the first nip position or the second nip position based on a type of the medium.

5. The recording device according to claim 4, wherein
the first nip position includes a first distance position where an interaxial distance that is a distance in the transport direction between the axial center position of the plurality of sub-rollers and the axial center position of the main roller is a first distance, and a second distance position where the interaxial distance is a second distance longer than the first distance and
the position changing section is configured to change positions of the plurality of sub-rollers with respect to the main roller at the first nip position to the first distance position or the second distance position based on the type of the medium.

6. The recording device according to claim 1, further comprising:
a support section that is arranged between the transport roller pair and the guide roller in the transport direction and that is provided at a position facing the recording section, wherein
the support section is configured to switch between a support state in which the medium is supported by a support surface and a non-support state in which the medium is not supported by the support surface.

7. The recording device according to claim 6, wherein
the support section is configured to switch between the support state and the non-support state based on a type of the medium.

8. The recording device according to claim 6, wherein
a position of the support surface in the support state in a facing direction in which the support surface and the recording section face each other is a position closer to the recording section than the nip position.

9. The recording device according to claim 8, wherein
the support section includes an inclined surface section connected to the support surface at an upstream end in the transport direction and
the inclined surface section is closer the recording section in the facing direction with greater advancement in the transport direction.
